(19) United States
(12) Patent Application Publication
(10) Pub. No.: US 2019/0339898 A1
(43) Pub. Date: Nov. 7, 2019

(54) METHOD, SYSTEM AND COMPUTER PROGRAM PRODUCT FOR MANAGING DATA STORAGE IN DATA STORAGE SYSTEMS

(71) Applicant: EMC IP Holding Company LLC, Hopkinton, MA (US)

(72) Inventors: Nickolay Dalmatov, St. Petersburg (RU); Vladimir Shatunov, Saint Petersburg (RU); Leonid Kozlov, Saint Petersburg (RU); Leonid Eremin, Saint-Petersburg (RU)

(73) Assignee: EMC IP Holding Company LLC, Hopkinton, MA (US)

(21) Appl. No.: 16/186,104

(22) Filed: Nov. 9, 2018

(30) Foreign Application Priority Data
May 3, 2018 (RU) 2018116424

(51) Int. Cl. G06F 3/06

(52) U.S. Cl. CPC G06F 3/0647; G06F 3/0685; G06F 3/0653; G06F 3/0604

(57) ABSTRACT

There is disclosed techniques for use in managing data storage in data storage systems. For example, in one embodiment, the techniques comprise monitoring I/O operations directed to a storage object in a data storage system. The techniques also comprise determining a measure of I/O trend relating to the storage object in response to the said monitoring. The techniques further comprise migrating data associated with the storage object from one tier of storage to another tier of storage in the data storage system based on the said measure of I/O trend.

### TECHNICAL FIELD

The present invention relates generally to data storage. More particularly, the present invention relates to a method, a system and a computer program product for managing data storage in data storage systems.

### BACKGROUND OF THE INVENTION

Data storage systems are arrangements of hardware and software that typically include multiple storage processors coupled to non-volatile data storage devices, such as magnetic disk drives, electronic flash drives, and/or optical drives. The storage processors service host I/O operations received from host applications running on host machines. The received host I/O operations specify one or more data storage objects to which they are directed (e.g. logical disks or “LUNs”), and indicate host I/O data that is to be written to or read from the storage objects. The storage processors include specialized hardware and execute specialized software that processes the incoming host I/O operations and that performs various data storage tasks that organize and secure the host I/O data that is received from the host applications and stored on non-volatile data storage devices of the data storage system.

In some previous data storage systems, non-volatile storage devices have been organized into physical disk groups based on the level of performance they provide. The different disk groups provide different performance “tiers” that are available within the data storage system, with higher performance disk groups (e.g. made up of solid state drives) providing higher performance tiers to the storage objects, and lower performance disk groups (e.g. made up of magnetic disk drives) providing lower performance tiers to the storage objects.

### SUMMARY OF THE INVENTION

There is disclosed a method, comprising: monitoring I/O operations directed to a storage object in a data storage system; in response to the said monitoring, determining a measure of I/O trend relating to the storage object; and based on the said measure of I/O trend, migrating data associated with the storage object from one tier of storage to another tier of storage in the data storage system.

There is also disclosed a system, comprising: memory; and processing circuitry coupled to the memory, the memory storing instructions which, when executed by the processing circuitry, cause the processing circuitry to: monitor I/O operations directed to a storage object in a data storage system; in response to the said monitoring, determine a measure of I/O trend relating to the storage object; and based on the said measure of I/O trend, migrate data associated with the storage object from one tier of storage to another tier of storage in the data storage system.

There is also disclosed a computer program product having a non-transitory computer readable medium which stores a set of instructions, the set of instructions, when carried out by processing circuitry, causing the processing circuitry to perform a method of: monitoring I/O operations directed to a storage object in a data storage system; in response to the said monitoring, determining a measure of I/O trend relating to the storage object; and based on the said measure of I/O trend, migrating data associated with the storage object from one tier of storage to another tier of storage in the data storage system.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram showing an operational example of a data storage environment including components in an embodiment of the disclosed technology;

FIG. 2 is an example graph in an embodiment of the disclosed technology; and

FIG. 3 is a flow chart illustrating steps performed during operation of some embodiments of the disclosed technology.

### DETAILED DESCRIPTION

Embodiments of the invention will now be described. It should be understood that the embodiments described herein are provided by way of example to illustrate various features and principles of the invention, and that the invention hereof is broader than the specific example embodiments disclosed.

Data storage systems may be provisioned with data storage drives of different types such that some types of drives are dedicated to store a performance critical part of a working set and other drives are dedicated to provide big and cheaper capacity for the rest of the set. For example, the first type of drive may be SSD and the latter type of drive may be NL-SAS.

Furthermore, data storage systems may export storage objects (e.g., LUNs) to a user, wherein different regions of a logical address space may be mapped to the different regions of physical space on the different drives. It should be noted that the systems may comprise an auto-tiering feature that periodically remaps the LUNs to keep the most actively used parts on the fastest drives in order to maximize performance. For example, the systems may monitor I/O related statistics, and aggregate them in order to filter out IO spikes and I/O fluctuations, to determine “temperature”. The higher the temperature of a space region the more actively it is accessed on a constant basis. So, as a result, the auto-tiering feature of the systems may put the regions with the highest temperature to the drives with the best performance characteristics (e.g., SSD) and the coldest regions may be moved to the storage with the cheapest capacity (e.g., NL-SAS).

Additionally, it should be understood that the auto-tiering feature of the systems may be configured to request statistics and update the temperatures on a periodic basis to have a consistent picture of I/O distribution. The auto-tiering feature may also initiate the relocation of the regions during a dedicated maintenance/relocation window (or alternatively upon receiving a request from the user). For example, the relocation window may typically open once a day because the I/O caused by the relocation should not impact the processing of the work load.

The problem with the above approach to tiering is that the analysis does not take I/O trend into consideration when determining which data to migrate. For example, the prior art approaches migrate data associated with a high temperature. However, in some cases, the promotion of a region with a lower temperature would be more beneficial because of its growing trend if the longer term effect is estimated.

By contrast, the current solution discussed in further detail below addresses this problem by taking into consideration the trend of the region's temperature when determining which data to migrate. The solution includes at least the following steps:

1. Requests I/O statistics periodically and maintains temperatures of the slices

2. Evaluate the trends of the temperature changing for the slices

3. Estimate the effect of the slice placement considering:
a. Trend
b. Duration between maintenance windows

4. Select slices, which placement would be the most beneficial.

The idea is to select the slice which will receive the most amount of I/O before the next maintenance window.

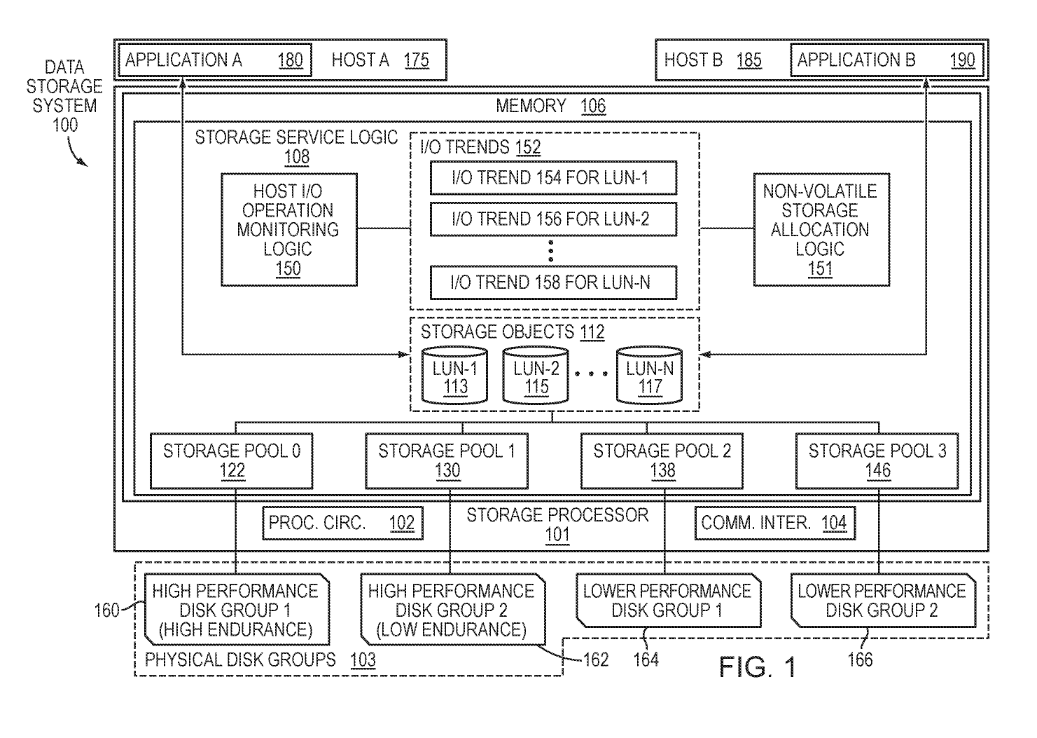

FIG. 1 is a block diagram showing an example of a data storage environment including components in an embodiment of the disclosed technology. As shown in FIG. 1, multiple host computing devices, shown by host A 175 and host B 185, include host applications executing thereon, e.g. application A 180 executing on host A 175 and application B 190 executing on host B 185. Host A 175 and host B 185 access non-volatile data storage provided by data storage system 100, for example over one or more computer networks, such as a local area network (LAN), and/or a wide area network (WAN) such as the Internet, etc. Data storage system 100 includes a storage processor 101 and physical disk groups 103. The data storage system 100 may include one or more storage processors like storage processor 101. Storage processor 101 may be provided as a circuit board assembly, or “blade,” which plugs into a chassis that encloses and cools multiple storage processors, and that has a backplane for interconnecting storage processors. However, no particular hardware configuration is required, and storage processor 101 may be embodied as any specific type of computing device capable of processing host input/output (I/O) operations (e.g. I/O reads and I/O writes).

Physical disk groups 103 may be directly physically connected to storage processor 101, or may be communicably connected to storage processor 101 by way of one or more computer networks. Physical disk groups 103 organize non-volatile storage devices by the level of performance they provide, in terms of response time and/or write endurance in the case of solid state drives (SSDs). For example, the different disk groups 103 may provide different performance tiers that are available within the data storage system. High performance disk group 1 160 and high performance disk group 2 162 are each made up of some number of high performance non-volatile storage devices. For example, both high performance disk group 1 160 and high performance disk group 2 162 may consist of one or more solid state drives (SSDs). Due to the characteristics of NAND flash, SSDs have a finite lifetime in terms of the number of write operations they can process, based on the number of program/erase (P/E) cycles that NAND flash can endure. Different types of SSDs provide different levels of write endurance, with higher endurance SSDs typically having a higher cost. For example, Single-Level Cell (SLC) NAND flash, which uses a single cell to store one bit of data, provides a relatively high level of write endurance, but at relatively higher cost. In another example, Multiple Level Cell (MLC)-based SSDs that use multiple bits per cell to store more bits typically cost less, but have relatively low write endurance. In the example of FIG. 1, high performance disk group 1 160 are made up of SSDs having relatively high write endurance levels (e.g. more costly SLC flash SSDs), while high performance disk group 2 162 are made up of SSDs having relatively lower write endurance levels (e.g. less costly MLC-based SSDs).

The lower performance disk groups shown by lower performance disk group 1 164, and lower performance disk group 2 166, are each made up of non-volatile storage devices that have lower performance in terms of response time than the non-volatile storage devices in high performance disk group 1 160 and high performance disk group 2 162. For example, the non-volatile storage devices in lower performance disk group 1 164 and lower performance disk group 2 166 may consist of a number of magnetic hard disk drives. Because the response time provided by magnetic hard disk drives is higher than the response time provided by the flash drives of high performance disk group 1 160 and high performance disk group 2 162, the non-volatile storage provided by each of lower performance disk group 1 164 and lower performance disk group 2 166 provides lower performance than the non-volatile storage provided by high performance disk groups 160 and 162.

Storage processor 101 includes one or more communication interfaces 104, processing circuitry 102, and memory 106. Communication interfaces 104 enable storage processor 101 to communicate with host A 175, host B 185, and physical disk groups 103 over one or more computer networks, and may include, for example, SCSI and/or other network interface adapters for converting electronic and/or optical signals received over one or more networks into electronic form for use by the storage processor 101. The processing circuitry 102 may, for example, include or consist of one or more microprocessors, e.g. central processing units (CPUs), multi-core processors, chips, and/or assemblies, and associated circuitry. Memory 106 may include volatile memory (e.g., RAM), and/or non-volatile memory, such as one or more ROMs, disk drives, solid state drives, and the like. Processing circuitry 102 and memory 106 together form control circuitry, which is constructed and arranged to carry out various methods and functions as described herein. The memory 106 stores a variety of software components that may be provided in the form of executable program code. For example, as shown in FIG. 1, memory 106 may include software components such as storage service logic 108. When the program code is executed by processing circuitry 102, processing circuitry 102 is caused to carry out the operations of the software components. Although certain software components are shown and described for purposes of illustration and explanation, those skilled in the art will recognize that memory 108 may include various other software components, such as an operating system, and various other applications, processes, etc.

During operation of the components shown in FIG. 1, storage service logic 108 provides data storage for use by one or more applications to data. In the example of FIG. 1, storage service logic 108 provides storage objects 112 to store data that is generated and/or used by application A 180 and/or application B 190. The storage objects 112 may, for example, include some number of logical disks (LUNs), shown by LUN-1 113, LUN-2 115, and so on through LUN-N 117. The storage objects 112 are provided by storage service logic 108 using units of non-volatile storage allocated from the physical disk groups 103.

Those skilled in the art will recognize that while the storage objects in the example of FIG. 1 are shown for purposes of illustration and explanation as LUNs, the disclosed techniques are not limited to use with LUNs. Alternatively, or in addition, the disclosed techniques may be applied to other types of storage objects that may be provided by the storage processor 101 to store data on behalf of one or more applications, such as host file systems, and/or VVols (virtual volumes, such as a virtual machine disk, e.g., as available from VMware, Inc. of Palo Alto, Calif.).

Further during operation of the embodiment shown in FIG. 1, storage service logic 108 uses storage pool 0 122, storage pool 1 130, storage pool 2 138, and storage pool 3 146 to allocate storage resources from the physical disk groups 103 to the storage objects 112. For example, the units of storage provided from the physical disk groups 103 by each one of the storage pools may be units of storage that are generally referred to as extents, which are allocated from respective ones of the physical disk groups 103 through the corresponding storage pools to storage objects 112. The extents provided as units of storage to storage objects 112 from storage pools 122, 130, 138 and 146 may be various specific increments of non-volatile storage space, e.g. 128 MB, 256 MB, 1 GB in size.

Each storage pool includes indications of the organization and/or amounts or sizes of the allocated and unallocated units of non-volatile storage managed by the storage pool, as well as indications (e.g. locations) of units of non-volatile storage in the non-volatile storage devices in the respective physical disk group that are currently allocated to storing host data in specific storage objects, and/or that are free and currently unallocated but available for allocation. In the example of FIG. 1, storage pool 0 122 includes indications of the units of storage allocated from high performance disk group 1 160 to specific storage objects in storage objects 112, and indications of units of storage in high performance disk group 1 160 that are available for allocation. Storage pool 1 130 includes indications of the units of storage allocated from high performance disk group 2 162 to specific storage objects in storage objects 112, and indications of units of storage in high performance disk group 2 160 that are available for allocation. Storage pool 2 138 includes indications of the units of storage allocated from lower performance disk group 1 164 to specific storage objects in storage objects 112, and indications of units of storage in lower performance disk group 1 164 that are available for allocation. And storage pool 3 146 includes indications of the units of storage allocated from lower performance disk group 2 166 to specific storage objects in storage objects 112, and indications of units of storage in lower performance disk group 2 166 that are available for allocation.

Further during operation of the embodiment shown in FIG. 1, in order to proactively allocate non-volatile storage from the physical disk groups 103 to the storage objects 112, host I/O operation monitoring logic 150 monitors the rate at which host I/O operations from host A 175 and/or host B 185 that are directed to individual ones of the LUNs in the storage objects 112 are received and/or processed during a monitored time period. Those skilled in the art will recognize that the rate at which host I/O operations directed to a storage object such as a LUN are received and/or processed may reflect the rate at which individual I/O operations directed to the storage object are received, and/or the size of the host data indicated by individual received I/O operations. Based on the monitored rate at which host I/O operations directed to individual storage objects are received and/or processed during the monitored time period, host I/O operation monitoring logic 150 identifies I/O trends 152 for one or more of the LUNs in storage objects 112. The host I/O operation monitoring logic 150 may identify the I/O trends by detecting a rate of increase or decrease of I/O operations for one of the LUNs in storage objects 112 within the monitored time period.

As shown in the example of FIG. 1, I/O trends 152 generated by host I/O operation monitoring logic 150 may include descriptions of one or more I/O trends for each individual LUN in storage objects 112, shown for purposes of illustration by I/O trend 154 for LUN-1, I/O trend 156 for LUN-2, and so on through I/O trend 158 for LUN-N. Each I/O trend 152 may include a rate of increase or decrease of I/O for the LUN. Furthermore, each I/O trend 152 may include a current temperature of data associated with that particular LUN and a potential temperature at a future time based on the current temperature and the rate. The I/O trends 152 may be embodied using a table, database, or any other appropriate data structure for a given embodiment.

Further during operation of the components shown in FIG. 1, for one or more LUNs with positive increasing I/O trends, a non-volatile storage allocation logic 151 may allocate some amount of high performance non-volatile storage, e.g. from high performance disk group 1 160 through storage pool 0 122, or from high performance disk group 2 162 through storage pool 1 130, to those LUNs. Advantageously, the high performance non-volatile storage allocated to the LUN is available to storage service logic 108 for processing host I/O operations directed to that LUN that are received for processing by storage processor 101. For example, a positive increasing I/O trend indicates an increasing number of host I/O operations directed to the LUN, and the high performance non-volatile storage allocated to the LUN is available to storage service logic 108 for storing host data indicated by one or more host I/O write operations directed to that LUN and received for processing by storage processor 101. The non-volatile storage allocation logic 151 may also deallocate high performance non-volatile storage allocated to LUNs for reallocation to one or more other LUNs based on I/O trends 152.

In some embodiments, the non-volatile storage allocation logic 151 may allocate an amount of high performance non-volatile storage to a given LUN based on the I/O trend for that LUN. For example, the non-volatile storage allocation logic 151 may allocate an amount of high performance non-volatile storage to the LUN that is located on at least one solid state drive within high performance disk group 1 160 and/or high performance disk group 2 162, e.g. using storage pool 0 122 and/or storage pool 1 130.

In some embodiments, the non-volatile storage allocation logic 151 may copy host data previously written to a LUN, and that is stored in low-performance non-volatile storage that was previously allocated to that LUN (e.g. from lower performance disk group 1 164 or lower performance disk group 2 166), from the low-performance non-volatile storage previously allocated to the LUN, to the high performance non-volatile storage allocated to the LUN. After copying the host data previously written to the LUN and stored in the low-performance non-volatile storage previously allocated to the LUN from the low-performance non-volatile storage previously allocated to the LUN to the high performance non-volatile storage allocated to the LUN, the non-volatile storage allocation logic 151 may deallocate the low-performance non-volatile storage previously allocated to the LUN for re-allocation to one or more other storage objects, e.g. by deallocating the low performance non-volatile storage previously allocated to the LUN into storage pool 2 138 or storage pool 3 146.

In some embodiments, the low performance non-volatile storage previously allocated to a LUN may be non-volatile storage allocated to the LUN that is located on at least one magnetic hard disk drive, e.g. from a magnetic hard disk drive in lower performance disk group 1 164 through storage pool 2 138, or from a magnetic hard disk drive in lower performance click group 2 156 through storage pool 3 146.

In some embodiments, host I/O operation monitoring logic 150 and/or non-volatile storage allocation logic 151 may calculate the amount of high performance non-volatile storage that is to be allocated to a given LUN as an amount of non-volatile storage that is sufficient to service the anticipated host I/O operations directed to that LUN. For example, the positive increasing I/O trend may include the I/O trend, the current temperature, and a potential future temperature at a future time. The amount of high performance non-volatile storage to be allocated equals at least the amount needed to service host I/O operations corresponding to the potential future temperature.

In some embodiments, individual LUNs in storage objects 112 may be related and/or associated with a storage object type. For example, some number of LUNs that are used to store a database may be associated with the defined type. After host I/O operation monitoring logic 150 identifies an I/O trend for a first one of the LUNs that is associated with the type, host I/O operation monitoring logic 150 may identify a second LUN that is also associated with the type. In response to identifying the second LUN associated with the type, host I/O operation monitoring logic 150 may then define the same I/O trend for the second LUN associated with the type as was previously defined for the first LUN associated with that type. In this way, LUNs having the same associated type can efficiently be assigned the same I/O trends.

In some embodiments, non-volatile storage allocation logic 151 may identify a second LUN having the same associated type as a first LUN, and in response to identifying the second LUN having the same associated type as the first LUN, in addition to allocating the amount of high performance non-volatile storage to the first LUN, also allocate the amount of high performance non-volatile storage to the second LUN. In this way, the amount of high performance non-volatile storage may also be allocated to the second LUN, based on the second LUN having the same associated type as the first LUN, and resulting in the amount of high performance non-volatile storage also being available for processing host I/O operations directed to the second storage object.

In some embodiments, further in response to monitoring the rate at which host I/O operations directed to individual LUNs are received and/or processed by storage processor 101 during the monitored time period, host I/O operation monitoring logic 150 may identify a negative decreasing I/O trend for one or more of the LUNs in storage objects 112. Identifying a negative decreasing I/O trend within the monitored time period may include detecting that a rate at which host I/O operations directed to a LUN are received and/or processed within the monitored time period is lower than a rate at which host I/O operations directed to other LUNs.

In response to identification of a negative decreasing I/O trend for a LUN, the non-volatile storage allocation logic 151 may then allocate an amount of low performance non-volatile storage to the LUN. The low performance non-volatile storage allocated to the LUN by non-volatile storage allocation logic 151 is available for processing host I/O operations directed to the storage object that are received for processing by the storage processor 101.

In some embodiments, host I/O monitoring logic 150 may identify a positive increasing I/O trend for a LUN within the monitored time period at least partly in response to detecting that a rate at which host I/O operations directed to the LUN are received and/or processed within the monitored time period is greater than a maximum rate at which host I/O operations can be processed using non-volatile storage allocated from either lower performance disk group 1 164 or lower performance disk group 2 166. For example, host I/O operation monitoring logic 150 may identify a LUN within the monitored time period at least partly in response to detecting that the rate at which host I/O operations directed to the LUN are received and/or processed within the monitored time period is greater than a maximum TOPS that can be processed using the lower performance disk drives in lower performance disk group 1 164 and/or lower performance disk group 2 166.

In some embodiments, host I/O operation monitoring logic 150 may identify a positive I/O trend for a LUN within the monitored time period at least partly in response to detecting that a rate at which host I/O operations directed to the LUN are received and/or processed within the monitored time period exceeds the rate at which host I/O operations are directed to one or more other storage objects during the monitored time period. For example, host I/O operation monitoring logic 150 may identify a positive increasing I/O trend for a LUN within the monitored time period only at least partly in response to detecting that a rate at which host I/O operations directed to the LUN exceeds the rate at which host I/O operations directed to the other storage object during the monitored time period.

In some embodiments, host I/O operation monitoring logic 150 may identify a positive increasing I/O trend for a LUN within the monitored time period at least partly in response to detecting that a rate at which host I/O operations directed to the LUN are received and/or processed within the monitored time period exceeds a threshold associated with one of the disk groups 103. For example, host I/O operation monitoring logic 150 may identify a positive increasing I/O trend for a LUN within the monitored time period only at least partly in response to detecting that a rate at which host I/O operations directed to the LUN exceeds a threshold associated with disk group 160.

In some embodiments, the host I/O operation monitoring logic 150 may monitor i) a rate at which write host I/O operations directed to individual LUNs are received and/or processed, and/or ii) a rate at which read host I/O operations directed to individual LUNs are received and/or processed. In such embodiments, for a given LUN the host I/O operation monitoring logic 150 may identify a positive increasing I/O trend for write host I/O operations that are directed to that LUN, and/or a positive increasing I/O trend for read host I/O operations that are directed to that LUN. In response to positive increasing I/O trend for write host I/O operations directed to an specific LUN, non-volatile storage allocation logic 151 may allocate the amount of high performance non-volatile storage to the LUN from high performance disk group 1 160 through storage pool 0 122, since the solid state drives in high performance disk group 1 160 have a higher write endurance than the solid state drives in high performance disk group 2 162, and can therefore sustain a higher total number of write host I/O operations before they are worn out. In contrast, in response to a positive increasing I/O trend for read host I/O operations directed to an individual LUN, non-volatile storage allocation logic 151 may allocate the amount of high performance non-volatile storage to the LUN from high performance disk group 2 162 through storage pool 1 130, since the solid state drives in high performance disk group 2 162 have lower write endurance than the solid state drives in high performance disk group 1 160, and cannot sustain as high a total number of write host I/O operations before they are worn out.

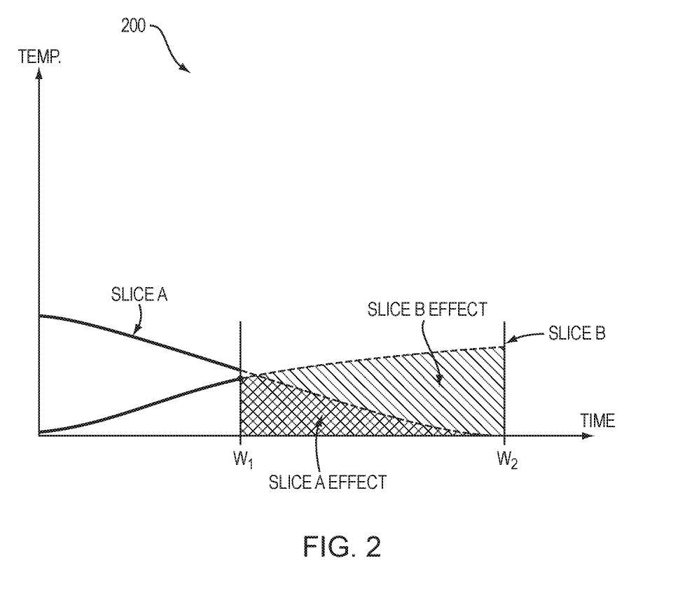

FIG. 2 further illustrates an example graph 200 in an embodiment of the disclosed technology. As shown in the example of FIG. 2, the graph 200 comprises an X axis describing time and a Y axis describing temperature. Furthermore, the graph 200 shows a first slice A and a second slice B. For example, as will be appreciated from FIG. 1, the slices may describe units of storage assigned to storage objects 112 from storage pools 122, 130, 138 and 146. In this particular example, slice A has a higher temperature than slice B at time W₁. However, as illustrated in the graph 200, the I/O trend associated with slice A indicates that the temperature is likely to be lower than slice B at time W₂ (N.B., the highlighted slice B effect area between time times W₁ and W₂). On the other hand, the I/O trend associated with slice B indicates that the temperature is likely to be higher than slice A at time W₂ (N.B., the highlighted slice B effect area between time times W₁ and W₂).

The host I/O operation monitoring logic 150 detects that slice A is hotter than slice B in the time W₁ (relocation window 1). However, the host I/O operation monitoring logic 150 also detects a measure of I/O trend for both slices. As a result, the host I/O operation monitoring logic 150 is aware that the amount of I/O directed to the slice B will be much bigger at W₂, which is the next time a relocation decision will be taken regarding the migration of data. So, in this example, data associated with slice B should be selected for promotion to the higher tier at time W₁. The non-volatile storage allocation logic 151 allocates storage as described above in light of the selection.

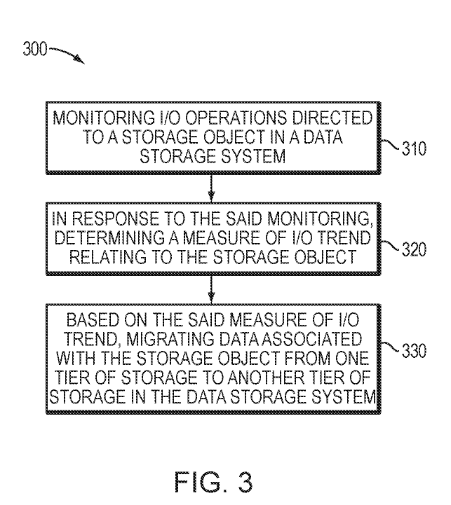

FIG. 3 shows an example method 300 that may be carried out in connection with the system 100. The method 300 typically performed, for example, by software components described in connection with FIG. 1, which reside in the memory 106 of the storage processor 101 and are run by the processing circuitry 102. The various acts of method 300 may be ordered in any suitable way. Accordingly, embodiments may be constructed in which acts are performed in orders different from that illustrated, which may include performing some acts simultaneously.

At step 310, monitoring I/O operations directed to a storage object in a data storage system. At step 320, determining a measure of I/O trend relating to the storage object in response to the said monitoring. For example, the measure of I/O trend describes a rate of increase or decrease of I/O operations relating to the storage object. At step 330, migrating data associated with the storage object from one tier of storage to another tier of storage in the data storage system based on the said measure of I/O trend.

In at least one embodiment of the invention, the data storage system is configured to migrate data during pre-defined time windows. The migration of the data associated with the storage object comprises (i) determining a temperature of the data describing an amount of activity in connection with the data, (ii) determining an amount of time to elapse before a future time window, (iii) determining a potential temperature of the data at the future time window based on the temperature, the amount of time, and the measure of I/O trend, and (iv) determining whether to migrate the data to the another tier before the future time window based on the potential temperature. The decision whether to migrate the data before the future time window comprises comparing the potential temperature of the data associated with the storage object and a temperature or a potential temperature associated with one or more other storage objects at the future time window. The decision whether to migrate the data before the future time window may alternatively comprise comparing the potential temperature of the data associated with the storage object and a threshold associated with the another tier in order to determine whether to migrate the data to the another tier.

While the above description provides examples of embodiments using various specific terms to indicate specific systems, devices, and/or components, such terms are illustrative only, and are used only for purposes of convenience and concise explanation. The disclosed system is not limited to embodiments including or involving systems, devices and/or components identified by the terms used above. For example, it should be understood that some data storage systems may be configured to run host applications such as application A 180 and application B 190 locally, i.e., in the memory 106 of the storage processor 101.

As will be appreciated by one skilled in the art, aspects of the technology disclosed herein may be embodied as a system, method or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method, comprising:
monitoring I/O operations directed to a storage object in a data storage system;
in response to the said monitoring, determining a measure of I/O trend relating to the storage object; and
based on the said measure of I/O trend, migrating data associated with the storage object from one tier of storage to another tier of storage in the data storage system.

2. The method as claimed in claim 1, wherein the measure of I/O trend describes a rate of increase or decrease of I/O operations relating to the storage object.

3. The method as claimed in claim 1, wherein migrating data associated with the storage object comprises determining to migrate the data based on a temperature of the data describing an amount of activity in connection with the data and the measure of I/O trend.

4. The method as claimed in claim 1, wherein the data storage system is configured to migrate data during pre-defined time windows; and
wherein migrating the data associated with the storage object, comprises:
determining a temperature of the data describing an amount of activity in connection with the data;
determining an amount of time to elapse before a future time window;
determining a potential temperature of the data at the future time window based on the temperature, the amount of time, and the measure of I/O trend; and
based on the potential temperature, determining whether to migrate the data to the another tier before the future time window.

5. The method as claimed in claim 4, wherein determining whether to migrate the data before the future time window comprises comparing the potential temperature of the data associated with the storage object and a temperature or a potential temperature associated with one or more other storage objects at the future time window.

6. The method as claimed in claim 4, wherein determining whether to migrate the data before the future time window comprises comparing the potential temperature of the data associated with the storage object and a threshold associated with the another tier in order to determine whether to migrate the data to the another tier.

7. A system, comprising:
memory; and
processing circuitry coupled to the memory, the memory storing instructions which, when executed by the processing circuitry, cause the processing circuitry to:
monitor I/O operations directed to a storage object in a data storage system;
in response to the said monitoring, determine a measure of I/O trend relating to the storage object; and
based on the said measure of I/O trend, migrate data associated with the storage object from one tier of storage to another tier of storage in the data storage system.

8. The system as claimed in claim 7, wherein the measure of I/O trend describes a rate of increase or decrease of I/O operations relating to the storage object.

9. The system as claimed in claim 7, wherein migrating data associated with the storage object comprises determining to migrate the data based on a temperature of the data describing an amount of activity in connection with the data and the measure of I/O trend.

10. The system as claimed in claim 7, wherein the data storage system is configured to migrate data during pre-defined time windows; and
wherein migrating the data associated with the storage object, comprises:
determine a temperature of the data describing an amount of activity in connection with the data;
determine an amount of time to elapse before a future time window;
determine a potential temperature of the data at the future time window based on the temperature, the amount of time, and the measure of I/O trend; and
based on the potential temperature, determine whether to migrate the data to the another tier before the future time window.

11. The system as claimed in claim 10, wherein determining whether to migrate the data before the future time window comprises comparing the potential temperature of the data associated with the storage object and a temperature or a potential temperature associated with one or more other storage objects at the future time window.

12. The system as claimed in claim 10, wherein determining whether to migrate the data before the future time window comprises comparing the potential temperature of the data associated with the storage object and a threshold associated with the another tier in order to determine whether to migrate the data to the another tier.

13. A computer program product having a non-transitory computer readable medium which stores a set of instructions, the set of instructions, when carried out by processing circuitry, causing the processing circuitry to perform a method of:
monitoring I/O operations directed to a storage object in a data storage system;
in response to the said monitoring, determining a measure of I/O trend relating to the storage object; and
based on the said measure of I/O trend, migrating data associated with the storage object from one tier of storage to another tier of storage in the data storage system.

14. The computer program product as claimed in claim 13, wherein the measure of I/O trend describes a rate of increase or decrease of I/O operations relating to the storage object.

15. The computer program product as claimed in claim 13, wherein migrating data associated with the storage object comprises determining to migrate the data based on a temperature of the data describing an amount of activity in connection with the data and the measure of I/O trend.

16. The computer program product as claimed in claim 13, wherein the data storage system is configured to migrate data during pre-defined time windows; and
wherein migrating the data associated with the storage object, comprises:
determining a temperature of the data describing an amount of activity in connection with the data;
determining an amount of time to elapse before a future time window;
determining a potential temperature of the data at the future time window based on the temperature, the amount of time, and the measure of I/O trend; and
based on the potential temperature, determining whether to migrate the data to the another tier before the future time window.

17. The computer program product as claimed in claim 16, wherein determining whether to migrate the data before the future time window comprises comparing the potential temperature of the data associated with the storage object and a temperature or a potential temperature associated with one or more other storage objects at the future time window.

18. The computer program product as claimed in claim 16, wherein determining whether to migrate the data before the future time window comprises comparing the potential temperature of the data associated with the storage object and a threshold associated with the another tier in order to determine whether to migrate the data to the another tier.
